(19) United States
(12) Patent Application Publication
(10) Pub. No.: US 2019/0059411 A1
(43) Pub. Date: Feb. 28, 2019

(54) MILK-COMPONENT-CONTAINING COFFEE BEVERAGE

(71) Applicant: SAN-EI GEN F.F.I., INC., Osaka (JP)

(72) Inventors: Takashi KONDA, Osaka (JP); Yasuharu SATO, Osaka (JP); Hiroshige UENO, Osaka (JP)

(21) Appl. No.: 15/768,985

(22) PCT Filed: Oct. 20, 2016
(86) PCT No.: PCT/JP2016/081040

§ 371 Date: Apr. 17, 2018

(30) Foreign Application Priority Data
Oct. 21, 2015 (JP) 2015-207090

(51) Int. Cl. A23F 5/24; A23C 9/156

(52) U.S. Cl. CPC A23F 5/243; A23C 9/156

(57) ABSTRACT

An object of the present invention is to provide a coffee beverage containing a milk component in which the precipitation generated by heat sterilization and/or upon storage of a coffee beverage containing a milk component is significantly inhibited by a simple method.

The object can be attained by incorporating three components: an organic acid, an organic acid salt, and an organic-acid ester of monoglyceride, in a coffee beverage containing a milk component.

### TECHNICAL FIELD

The present invention relates to a coffee beverage containing a milk component.

### BACKGROUND ART

Coffee beverages containing a milk component (such a beverage may also be referred to as “a coffee beverage containing a milk component” in this specification) have been consumed by various consumers due to their favorable characteristics, such as the enjoyable rich flavor derived from a milk component. On the other hand, the beverages have a drawback of generating precipitation due to, for example, the interaction between a milk component and a coffee component, heat sterilization upon the manufacture of the beverages (during and/or after the heat sterilization), and/or during storage (in particular, during long-term storage), and the precipitation results in a quality decrease.

As a technique for inhibiting such precipitation focusing on the type of emulsifier, or the like, for example, Patent Document 1 discloses a method for stabilizing a coffee beverage with a high raw-coffee bean content, comprising incorporating 0.03 to 0.04 mass % of sodium caseinate, 0.005 to 0.5 mass % of sorbitan ester of fatty acid, and 0.015 to 0.4 mass % of microcrystalline cellulose, in a coffee beverage.

Further, as a technique focusing on materials other than the emulsifier, Patent Document 2 discloses a method of incorporating 0.005 to 0.2 wt % of one member, or two or more members selected from citric acid, malic acid, tartaric acid, lactic acid, and phosphoric acid, and 0.075 to 0.25 wt % of sodium bicarbonate. Further, as a technique focusing on the production method of a coffee beverage, Patent Document 3 discloses a method of UHT sterilization separately for a liquid coffee extract and a milk-protein-containing liquid.

### CITATION LIST

### Patent Documents

Patent Document 1: JP2012-105638A
Patent Document 2: Japanese Patent No. 4503285
Patent Document 3: JP2015-33368A

### SUMMARY OF INVENTION

### Technical Problem

The technique disclosed in Patent Document 1 is a technique using sodium caseinate as an essential ingredient.

Sodium caseinate has been generally used as a precipitation inhibitor for a coffee beverage containing a milk component as in Patent Document 1. Sodium caseinate is an excellent precipitation inhibitor. However, since Sodium caseinate is a material produced by neutralizing a precipitate (acid casein) generated by adding an acid to a skim milk obtained from milk, there is a risk of supply instability and price increase of sodium caseinate because of the decrease in production amount due to the short supply of milk itself, as well as the increase in demand for milk-derived materials, such as skim milk.

The techniques disclosed in Patent Documents 2 and 3 both ensure a certain precipitation inhibiting effect in a coffee beverage containing a milk component; however, a further improvement in the precipitation inhibiting effect is desired in these techniques.

Further, in the technique disclosed in Patent Document 2, when the content of organic acid is increased to ensure a sufficient precipitation inhibiting effect, the distinctive taste of organic acid may adversely affect the taste of the beverage. Further, this technique causes an easy decrease in the pH of the beverage during storage, and may result in precipitation of the milk component, contrary to the original purpose of the addition of the organic acid.

Further, the technique disclosed in Patent Document 3 requires separate UHT sterilization for a liquid coffee extract and a milk-protein-containing solution; this requires the production line to be designed according to such a production process, and also causes a problem of a lower manufacturing efficiency if the manufacture is performed in current facilities, and the like.

In light of such problems, an object of the present invention is to provide a technique of conveniently and efficiently inhibiting the precipitates by heat sterilization (during and/or after the heat sterilization) and/or upon storage of a coffee beverage containing a milk component.

### Solution to Problem

The inventors of the present invention conducted extensive research to solve the above problems, and found that, by incorporating three substances, i.e., organic acid, organic acid salt, and organic-acid ester of monoglyceride, in a coffee beverage containing a milk component, it is possible to significantly inhibit the precipitation by heat sterilization (during and/or after the heat sterilization) and/or upon storage (in particular, during long-term storage) of the beverage. With this finding, the inventors completed the present invention.

In this specification, the precipitation by heat sterilization may mean precipitation upon and/or after the heat sterilization.

More specifically, the present invention relates to the coffee beverage containing a milk component, the methods for producing the coffee beverage containing a milk component, the methods for inhibiting precipitation of a coffee beverage containing a milk component, and the like, according to the following aspects.
Item 1. A coffee beverage containing a milk component comprising an organic acid, an organic acid salt, and an organic-acid ester of monoglyceride.
Item 2. The coffee beverage containing a milk component according to Item 1, wherein the coffee beverage containing a milk component comprises 2.5 mass % or more of a coffee component in an amount of raw coffee beans.
Item 3. The coffee beverage containing a milk component according to Item 1 or 2, wherein the coffee beverage containing a milk component comprises 0.4 mass % or more of a milk component in an amount of nonfat milk solid.
Item 4. The coffee beverage containing a milk component according to any one of Items 1 to 3, wherein the coffee beverage containing a milk component comprises, as the organic acid, one or more members selected from the group consisting of malic acid, tartaric acid, and citric acid.
Item 5. The coffee beverage containing a milk component according to any one of Items 1 to 4, wherein the amount of the organic acid is not less than 50 ppm and less than 300 ppm.
Item 6. The coffee beverage containing a milk component according to any one of Items 1 to 5, wherein the coffee beverage containing a milk component comprises, as the organic acid salt, one or more members selected from the group consisting of citrates, malates, phosphates, and tartrates.
Item 7. A method for inhibiting precipitation generated upon storage of a coffee beverage containing a milk component, comprising incorporating an organic acid, an organic acid salt, and an organic-acid ester of monoglyceride in the coffee beverage containing a milk component.
Item 8. A method for producing a coffee beverage containing a milk component, comprising incorporating an organic acid, an organic acid salt, and an organic-acid ester of monoglyceride in the coffee beverage containing a milk component.

### Advantageous Effects of Invention

The present invention provides a coffee beverage containing a milk component in which precipitation generated by heat sterilization and/or upon storage (in particular, during long-term storage) is significantly inhibited.

### BRIEF DESCRIPTION OF DRAWINGS

FIG. 1: An image showing a state of precipitation in a can bottom after a coffee beverage containing a milk component of Example 3-1 was stored at 80° C. for 3 days in Experiment Example 3.

FIG. 2: An image showing a state of precipitation in a can bottom after a coffee beverage containing a milk component of Example 3-2 was stored at 80° C. for 3 days in Experiment Example 3.

FIG. 3: An image showing a state of precipitation in a can bottom after a coffee beverage containing a milk component of Reference Example 3-1 was stored at 80° C. for 3 days in Experiment Example 3.

### DESCRIPTION OF EMBODIMENTS

In this specification, the unit “ppm” means ppm (w/w), unless otherwise specified.

The coffee beverage containing a milk component of the present invention is characterized by the combined use of three substances: organic acid, organic acid salt, and organic-acid ester of monoglyceride.

The organic acid used in the present invention is not particularly limited insofar as it is an acid of an organic compound usable for food and drinks. Examples of organic acids usable in the present invention include malic acid, tartaric acid, citric acid, gluconic acid, glucono delta lactone, phytic acid, succinic acid, fumaric acid, acetic acid, lactic acid, adipic acid, ascorbic acid, erythorbic acid and the like. Preferable organic acid is one or more members selected from the group consisting of malic acid, tartaric acid, citric acid, succinic acid, ascorbic acid, phytic acid, and the like. Further, in the present invention, an organic acid having an acid dissociation constant (pKal) of 2.5 to 3.3 is preferable. Examples of such organic acid include one or more members selected from the group consisting of malic acid, tartaric acid, and citric acid. In the present invention, further preferable organic acids are malic acid and/or citric acid.

The amount of the organic acid in the coffee beverage containing a milk component of the present invention is, for example, 5 to 300 ppm.

In view of the palatability (specifically, to minimize, in particular, the difference in the quality of taste from that of a coffee beverage containing a milk component free of organic acid), the amount of the organic acid is preferably less than 300 ppm, more preferably 250 ppm or less, further preferably 200 ppm or less, further more preferably 180 ppm or less, and particularly preferably 130 ppm or less.

In previously known coffee beverages containing a milk component, as the amount of the organic acid decreases, the precipitation generated by heat sterilization and/or upon storage tends to significantly increase. In contrast, since organic acid salt and organic-acid ester of monoglyceride are used in combination with the organic acid in the coffee beverage containing a milk component of the present invention, the present invention provides a coffee beverage containing a milk component in which the precipitation generated by heat sterilization and/or upon storage is significantly inhibited even when the beverage contains a small amount of organic acid.

The lower limit amount of the organic acid may be very low, and is generally 5 ppm or more, preferably 20 ppm or more, more preferably 40 ppm or more, and further preferably 50 ppm or more.

More specifically, for example, when citric acid is used alone as the organic acid, the amount of the citric acid is preferably 200 ppm or less, more preferably 100 ppm or less, further preferably less than 100 ppm, further more preferably 80 ppm or less, and particularly preferably 70 ppm or less, and more particularly preferably 50 ppm or less.

The amount may be generally 5 ppm or more, preferably 10 ppm or more, and more preferably 20 ppm or more.

Any organic acid salts usable for food and drinks may be used for the present invention without particular limitation. Examples include salts of the organic acids listed above. Examples of the organic acid salts include potassium salts, sodium salts, magnesium salts, calcium salts, and the like.

One kind of organic acid salt may be used solely or two or more organic acid salts may be used in combination.

Among the above-listed salts, potassium salt, sodium salt and combinations thereof are preferable.

Examples of organic acid salts include sodium malic acid, potassium malic acid, potassium citrate, (e.g., tripotassium citrate, dipotassium citrate, monopotassium citrate, and the like), sodium citrate (e.g., trisodium citrate, disodium citrate, monosodium citrate, and the like), sodium gluconate, sodium tartrate, disodium hydrogen phosphate, sodium dihydrogen phosphate, and the like.

Among the above-listed organic acid salts, more preferable organic acid salts are one or more members selected from the group consisting of potassium citrate, sodium citrate, sodium malate, and sodium gluconate. Further preferable organic acid salts are one or more members selected from the group consisting of sodium malate, potassium citrate, and sodium citrate.

The amount of the organic acid salt in the coffee beverage containing a milk component of the present invention is, for example, 5 to 300 ppm.

The amount of the organic acid salt is preferably 15 to 250 ppm, more preferably 25 to 200 ppm, further preferably 30 to 180 ppm, and further more preferably 40 to 150 ppm.

The coffee beverage containing a milk component of the present invention contains 0.01 to 10 parts by mass, more preferably 0.1 to 5 parts by mass, and further preferably 0.3 to 3 parts by mass of organic acid salt, per part by mass of the organic acid.

The organic-acid ester of monoglyceride used in the present invention has a structure in which a hydroxy group of a glycerol ester of mono-fatty acid, which results from an ester bond of a fatty acid to one of the three hydroxy groups of glycerin, is further bonded to an organic acid.

Examples of organic-acid ester of monoglyceride usable in the present invention include succinylated monoglyceride, diacetyltartaric and fatty acid esters of glycerol, citric and fatty acid esters of glycerol, acetic and fatty acid esters of glycerol, lactic and fatty acid esters of glycerol, and the like.

One kind of organic-acid ester of monoglyceride may be used solely or two or more organic-acid ester of monoglycerides may be used in combination.

Among these, a preferable organic-acid ester of monoglyceride is one or more members selected from the group consisting of succinylated monoglyceride, diacetyltartaric and fatty acid esters of glycerol, and citric acid and fatty acid esters of glycerol. succinylated monoglyceride and/or diacetyltartaric and fatty acid esters of glycerol are more preferable.

In the present invention, in particular, organic-acid esters of monoglycerides of poly-carboxylic acids (e.g., bivalent carboxylic acid, trivalent carboxylic acid, tetravalent carboxylic acid) are preferably used.

In the present invention, in particular, an organic-acid ester of monoglyceride in which a —COOH group remains is preferably used.

In the organic-acid ester of monoglyceride used in the present invention, the type of fatty acid bonded to the glycerin is not particularly limited. Examples of fatty acids include stearic acid, palmitic acid, myristic acid, lauric acid, oleic acid, behenic acid, palmitoleic acid, linolenic acid, linoleic acid, arachidic acid, or like saturated or unsaturated fatty acids having about 12 to 25 carbon atoms.

The organic-acid ester of monoglyceride used in the present invention may have a structure in which one fatty acid selected from the fatty acids listed above is bonded to the glycerin, or two or more of the fatty acids are bonded to the glycerin.

The fatty acid constituting the organic-acid ester of monoglyceride used in the present invention is preferably one or more members selected from the group consisting of stearic acid, palmitic acid, myristic acid, lauric acid, oleic acid and behenic acid, more preferably one or more members selected from the group consisting of stearic acid, palmitic acid and myristic acid.

The HLB of the organic-acid ester of monoglyceride used in the present invention is not particularly limited; the HLB is preferably 2 to 16, more preferably 2.5 to 13, and further preferably 3 to 10.

The amount of the organic-acid ester of monoglyceride in the coffee beverage containing a milk component of the present invention is, for example, 10 to 600 ppm.

The amount of the organic-acid ester of monoglyceride is preferably 15 to 500 ppm, more preferably 20 to 400 ppm, further preferably 30 to 350 ppm, and further preferably 40 to 280 ppm.

The coffee beverage containing a milk component of the present invention contains 0.1 to 20 parts by mass, more preferably 0.3 to 15 parts by mass, further preferably 0.5 to 10 parts by mass, and further more preferably 0.5 to 6 parts by mass of organic-acid ester of monoglyceride, per part by mass of the organic acid.

The coffee beverage containing a milk component of the present invention contains preferably 0.1 to 20 parts by mass, more preferably 0.3 to 15 parts by mass, and further preferably 0.5 to 10 parts by mass, and further more preferably 0.5 to 6 parts by mass of organic-acid ester of monoglyceride, per part by mass of the organic acid salt.

With the combined use of organic acid, organic acid salt, and organic-acid ester of monoglyceride as essential ingredients, the coffee beverage containing a milk component of the present invention significantly suppresses precipitation generated by heat sterilization and/or upon storage (in particular, during long-term storage) even without using the sodium caseinate that has generally been used as a precipitation inhibitor or even when a small amount of sodium caseinate is used.

Therefore, the present invention provides a coffee beverage containing a milk component in which the precipitation generated by heat sterilization and/or upon storage (in particular, during long-term storage) is significantly inhibited even without using sodium caseinate having a risk of unstable provision or price increase, or even when a small amount of sodium caseinate is used.

When the coffee beverage containing a milk component of the present invention contains sodium caseinate, the amount of the sodium caseinate is preferably 20 parts by mass or less, more preferably 10 parts by mass or less, and further preferably 5 parts by mass or less, and further more preferably 1.5 parts by mass or less, and particularly preferably 1 part by mass or less, per part by mass of organic-acid ester of monoglyceride.

In this case, the amount of sodium caseinate in the coffee beverage containing a milk component of the present invention is preferably less than 800 ppm, more preferably 600 ppm or less, further preferably less than 450 ppm, and further more preferably 300 ppm or less.

In the present invention, “coffee beverage” refers to a beverage product produced by using a coffee component as one of the raw materials, through a heat sterilization process. The type of the product is not particularly limited. Examples of the products mainly include “coffee,” “coffee beverage,” and “soft drink containing coffee” included in the definition of “fair competition rules for labeling of coffee beverages and the like” established in 1977 in Japan. Further, in Japan, in accordance with the “fair competition rules for milk beverage labeling,” a beverage containing a milk solid in an amount of 3 mass % or more is regarded as a “milk beverage” even if it is made by using a coffee component as a raw material. Such a beverage is also encompassed in the range of the coffee beverage of the present invention.

Regarding the coffee component used for the coffee beverage containing a milk component of the present invention, the species of beans, quality, roasting method, roasting degree, extraction conditions and the like are not particularly limited. For example, examples of the species of beans include coffea arabica, coffea robusta, coffea liberica, and the like. Further, the L value indicating the bean roasting degree is, for example, 15 to 28, and 16 to 23.

In the present invention, a liquid coffee extract extracted from coffee beans may directly be used as a coffee component, or instant coffee or concentrated coffee obtained by the liquid coffee extract may be used as a coffee component.

The amount of the coffee component in the coffee beverage containing a milk component of the present invention is not particularly limited. For example, the amount is 2.5 to 15 mass % in an amount of raw coffee beans. In terms of the palatability of coffee beverages, an increase in the amount of raw coffee beans enhances the coffee flavor, and a desirable beverage (for example, a beverage with the real taste of coffee) can be obtained.

In previously known coffee beverage containing a milk component, generally, as the amount of the coffee component in the coffee beverage containing a milk component increases, more precipitation is generated by heat sterilization and/or upon storage.

However, according to the present invention, even when the coffee beverage containing a milk component contains, for example, 3 mass % or more, 4 mass % or more, in particular, 5 mass % or more of a coffee component in an amount of raw coffee beans, it is possible to provide a beverage in which precipitation is significantly inhibited.

The milk component used for the coffee beverage of the present invention is not particularly limited, insofar as it is a milk component usable for food and drinks. Examples of the milk component include raw milk and processed products thereof (e.g., rich cow's milk, low-fat milk, skim milk, concentrated milk, skim concentrated milk, whole milk powder, modified milk powder, skim milk powder, condensed milk, fermented milk, creams, cheese, butter, whey powder, buttermilk powder, and the like).

The amount of the milk component in the coffee beverage containing a milk component of the present invention is not particularly limited. For example, the amount of the milk component is 0.4 to 6 mass % in an amount of nonfat milk solid.

In previously known the coffee beverage containing a milk component, generally, as the amount of milk component increases, the precipitation generated by heat sterilization and/or upon storage tends to increase.

In contrast, according to the present invention, it is possible to provide a beverage in which the precipitation is significantly inhibited while ensuring an excellent flavor derived from a milk component, even when the amount of milk component is, for example, 0.6 mass % or more, further, 0.8 mass % or more, and in particular, 1 mass % or more, in an amount of nonfat milk solid.

The pH of the coffee beverage containing a milk component of the present invention is preferably 6 to 7, more preferably 6 to 6.8, and further preferably 6.1 to 6.6 after sterilization.

The coffee beverage containing a milk component of the present invention may be produced by a usual method for producing a coffee beverage containing a milk component, except for the incorporation of organic acid, organic acid salt, and organic-acid ester of monoglyceride in the beverage.

The incorporation of organic acid, organic acid salt, and organic-acid ester of monoglyceride in the beverage may be performed by mixing the “organic acid, organic acid salt, and organic-acid ester of monoglyceride” with materials of the coffee beverage containing a milk component of the present invention other than the “organic acid, organic acid salt, and organic-acid ester of monoglyceride.”

The mixing may be performed by a known mixing method.

For example, although two examples of production methods for the coffee beverage containing a milk component of the present invention are described below, the present invention is not limited to these examples.

### Method I:

Extraction by filtration was performed by adding, to ground roasted-coffee beans, hot water (e.g., 80 to 100° C.) in an amount of 5 to 15 times the amount of the coffee beans, thereby obtaining a liquid coffee extract.

Separately, organic acid, organic acid salt, and organic-acid ester of monoglyceride, and other optional components (e.g., emulsifier other than the organic-acid ester of monoglyceride (in this specification, this emulsifier may simply be referred to as “other emulsifier(s)”), sugars, etc.) were added to water, and the resulting mixture was warmed to 60 to 80° C., thereby preparing an emulsifier-containing solution.

The emulsifier-containing solution, the liquid coffee extract, and a milk component were mixed to prepare a raw material liquid.

After the raw material liquid was warmed as necessary, a homogenization and a sterilization were performed to prepare a coffee beverage.

### Method II:

Extraction by filtration was performed by adding, to ground roasted-coffee beans, hot water (e.g., 80 to 100° C.) in an amount of 5 to 15 times the amount of the coffee beans, thereby obtaining a liquid coffee extract.

Separately, organic acid, organic acid salt, organic-acid ester of monoglyceride, a milk component, and other optional components (e.g., other emulsifiers, sugars, etc.) were added to the water, and the resulting mixture was warmed to 60 to 80 ° C., thereby preparing an emulsifier-containing solution containing a milk component.

The emulsifier-containing solution and the liquid coffee extract were mixed to prepare a raw material liquid.

After the raw material liquid was warmed as necessary, a homogenization and a sterilization were performed to prepare a coffee beverage.

The methods and the conditions in the mixing, homogenization, and heat sterilization in this production method may be appropriately selected and determined according to common technical knowledge.

As for specific examples of the method and the conditions of the homogenization in this production method, for example, a high-pressure homogenization process at 5 to 30 MPa·s may be performed.

As for specific examples of the method and the conditions of the heat sterilization in this production method, for example, a retort sterilization at 110 to 130° C. for 2 to 60 minutes, or a UHT sterilization at 120 to 150° C. for 2 to 60 seconds may be performed.

The “method for inhibiting precipitation” of the present invention may be understood from the above description of the production method.

### EXAMPLES

Hereinbelow, the present invention is more specifically described with reference to Examples. However, the present invention is not limited to the following Examples.

### Experiment Example 1

### Coffee Beverage Containing a Milk Component (1)

### Preparation of Liquid Coffee Extract

Extraction of coffee beans was performed by adding, to roughly ground roasted-coffee beans (coffea arabica, L value=20), hot water in an amount of 10 times the amount of coffee beans, thereby obtaining a liquid coffee extract having a brix of 3.3.

### Preparation of Emulsifier-Containing Solution

According to the formulas shown in Tables 1 and 2, sugar, organic acid, organic acid salt, organic-acid ester of monoglyceride, and sucrose ester of fatty acid were added to ion exchanged water as required, and the mixture was heated at 80° C. for 10 minutes, then cooled to room temperature, thereby preparing an emulsifier-containing solution.

### Preparation of Coffee Beverage Containing a Milk Component

The liquid coffee extract, the emulsifier-containing solution, cow's milk and sodium bicarbonate were mixed. The mixture was heated to 75° C.; thereafter, a homogenization was performed using a high-pressure homogenizer (condition: first step: 10 Mpa, second step: 5 Mpa). After the homogenization, the mixture was filled in a container (can), followed by retort sterilization at 123° C. for 20 minutes, thereby preparing a coffee beverage containing a milk component (Examples 1-1 to 1-9, and Comparative Examples 1-1 to 1-2).

The pH of each coffee beverage containing a milk component after sterilization was 6.2 to 6.3.

As Reference Examples, a coffee beverage containing a milk component of Example 1-1 free of organic acid, organic acid salt, and organic-acid ester of monoglyceride; and coffee beverage containing a milk component of Reference Examples 1-2 and 1-3 in which sodium caseinate as a precipitation inhibitor was added to the beverage of Reference Example 1-1 were prepared.

TABLE 1

| Formula of Coffee beverage containing a milk component | Mass % |
|---|---|
| Liquid coffee extract | 42.4 |
| Cow's Milk | 15 |
| Sugar | 6 |
| Organic Acid | See Table 2 |
| Organic Acid Salt | See Table 2 |
| Organic-acid ester of monoglyceride | See Table 2 |
| Sodium caseinate | See Table 2 |
| Sucrose Ester of Fatty Acid | 0.05 |
| Sodium Bicarbonate | 0.11 |
| Total following the Addition of Ion Exchange Water | 100 |
| Coffee Component (Amount of Raw Coffee Beans) | 7 |
| Milk Component(Amount of Nonfat Milk Solid) | 1.3 |

TABLE 2

| | | | | | | Organic-acid ester of | |
|---|---|---|---|---|---|---|---|
| | Sodium | Organic Acid | | Organic Acid Salt | | monoglyceride | |
| | caseinate | | Content | | Content | | Content |
| | (ppm) | Type | (ppm) | Type | (ppm) | Type | (ppm) |
| Reference | — | — | — | — | — | — | — |
| Example 1-1 | | | | | | | |
| Reference | 500 | — | — | — | — | — | — |
| Example 1-2 | | | | | | | |
| Reference | 1000 | — | — | — | — | — | — |
| Example 1-3 | | | | | | | |
| Example 1-1 | — | Tartaric | 75 | Potassium | 75 | Diacetyltartaric | 150 |
| | | Acid | | Citrate | | and fatty | |
| | | | | | | acid esters of | |
| | | | | | | glycerol | |
| Example 1-2 | — | Malic | 75 | Potassium | 75 | Diacetyltartaric | 150 |
| | | Acid | | Citrate | | and fatty | |
| | | | | | | acid esters of | |
| | | | | | | glycerol | |
| Example 1-3 | — | Malic | 75 | Potassium | 75 | Succinylated | 150 |
| | | Acid | | Citrate | | Monoglycerides | |
| Example 1-4 | — | Malic | 75 | Sodium | 75 | Succinylated | 150 |
| | | Acid | | Citrate | | Monoglycerides | |
| Example 1-5 | — | Citric | 75 | Potassium | 75 | Diacetyltartaric | 150 |
| | | Acid | | Citrate | | and fatty | |
| | | | | | | acid esters of | |
| | | | | | | glycerol | |
| Example 1-6 | | Citric | 75 | Sodium | 75 | Succinylated | 150 |
| | | Acid | | Malate | | Monoglycerides | |
| Example 1-7 | — | Citric | 75 | Potassium | 75 | Citric and | 150 |
| | | Acid | | Citrate | | Fatty Acid | |
| | | | | | | Esters of | |
| | | | | | | Glycerol | |
| Example 1-8 | — | Citric | 40 | Potassium | 50 | Succinylated | 150 |
| | | Acid | | Citrate | | Monoglycerides | |
| Example 1-9 | — | Phytic | 75 | Potassium | 75 | Diacetyltartaric | 150 |
| | | Acid | | Citrate | | and fatty | |
| | | | | | | acid esters of | |
| | | | | | | glycerol | |
| Comparative | — | Tartaric | 75 | Potassium | 75 | — | — |
| Example 1-1 | | Acid | | Citrate | | | |
| Comparative | — | — | — | Potassium | 100 | Diacetyltartaric | 200 |
| Example 1-2 | | | | Citrate | | and fatty | |
| | | | | | | acid esters of | |
| | | | | | | glycerol | |

In all Examples and Comparative Examples, the following materials were used.
Potassium citrate: Tripotassium citrate:
Sodium citrate: Trisodium citrate:
Diacetyltartaric and fatty acid esters of glycerol: containing stearic acid and palmitic acid as constituent fatty acids (HLB 5-8).

Succinylated Monoglycerides: containing stearic acid and palmitic acid as constituent fatty acids (HLB 5.3).

Citric and Fatty Acid Esters of Glycerol: containing stearic acid and palmitic acid as constituent fatty acids (HLB 3).

A storage stability test of the prepared coffee beverage containing a milk component was performed.

### Storage Stability Test

After each prepared coffee beverage containing a milk component was stored at 80° C. for 3 days, the container (can) was opened. Subsequently, the content (beverage) was transferred to a beaker, and the state of the precipitate that remained in the can bottom was visually evaluated.

The precipitation amount was visually evaluated as follows in order from the largest to the smallest precipitation: +++>++>+>±>−.

The beverage sample with large amount of precipitation comparing to that in Reference Example 1-1 was rated “+++”.

The beverage sample with same amount of precipitation comparing to that in Reference Example 1-2 was rated “±”.

The beverage sample with same amount of precipitation comparing to that in Reference Example 1-3 (that is, the precipitation amount was greatly reduced compared with that of Reference Example 1-1, i.e., the precipitation amount was small or precipitation was hardly observed) was rated “−”.

Similar tests were performed by changing the storage condition to 60° C. for 2 weeks, and 37° C. for 4 weeks.

Table 3 shows the results.

TABLE 3

| | 80° C., 3 Days | 60° C., 2 Weeks | 37° C., 4 Weeks |
|---|---|---|---|
| | Storage | Storage | Storage |
| | Stability | Stability | Stability |
| Reference | +++ | +++ | ++ |
| Example 1-1 | | | |
| Reference | ± | ++ | ± |
| Example 1-2 | | | |
| Reference | − | + | − |
| Example 1-3 | | | |
| Example 1-1 | − to ± | ± to + | ± |
| Example 1-2 | − to ± | ± to + | ± |
| Example 1-3 | ± | + | ± |
| Example 1-4 | + | + | ± |
| Example 1-5 | − to ± | ± to + | − to ± |
| Example 1-6 | ± | + | ± |
| Example 1-7 | ± | + | ± |
| Example 1-8 | ± | + | ± |
| Example 1-9 | + | + | ± |
| Comparative | + to ++ | +++ | ++ to +++ |
| Example 1-1 | | | |
| Comparative | ++ | ++ to +++ | ++ |
| Example 1-2 | | | |

As shown in Table 3, the precipitation was significantly inhibited in the coffee beverage containing a milk component of Examples 1-1 to 1-9 in which organic acid, organic acid salt, and organic-acid ester of monoglyceride were used together even though the beverages did not contain sodium caseinate, and were stored under a severe condition, i.e., at 80° C. for 3 days. More specifically, there was little precipitation or very small precipitation in these examples.

Substantially similar results were obtained also after storage at 60° C. for 2 weeks, and storage at 37° C. for 4 weeks.

Further, since the coffee beverage containing a milk component of Examples 1-1 to 1-9 contained a small amount of organic acid and the like, they maintained the taste of a coffee beverage; thus, these coffee beverage containing a milk component of the taste, the beverages of Examples 1-1, 1-2, and 1-3 were particularly superior.

In contrast, a large amount of precipitation was observed in the container bottom in the coffee beverage containing a milk component of Comparative Example 1-1 free of organic-acid ester of monoglyceride, and the coffee beverage containing a milk component of Comparative Example 1-2 free of organic acid.

### Experiment Example 2

### Coffee Beverage Containing a Milk Component (2)

Coffee beverage containing a milk component were prepared in the same manner as in Experiment Example 1, except that the amounts of the organic acid, organic acid salt, and organic-acid ester of monoglyceride were changed according to the formula shown in Table 4-1. The pH of each coffee beverage containing a milk component after sterilization was 6.2 to 6.3.

A storage stability test of the prepared coffee beverage containing a milk component was performed in the same manner as in Experiment Example 1, i.e., at 80° C. for 3 days, at 60° C. for 2 weeks, and at 37° C. for 4 weeks, and the precipitation state was evaluated.

Table 4-2 shows the results.

TABLE 4-1

| | | | | | Organic-acid ester of | |
|---|---|---|---|---|---|---|
| | Organic Acid | | Organic Acid Salt | | monoglyceride | |
| | | Content | | Content | | Content |
| | Type | (ppm) | Type | (ppm) | Type | (ppm) |
| Example 2-1 | Malic Acid | 75 | Potassium | 100 | Diacetyltartaric and | 150 |
| | | | Citrate | | fatty acid esters | |
| | | | | | of glycerol | |
| Example 2-2 | Malic Acid | 75 | Potassium | 50 | Diacetyltartaric and | 150 |
| | | | Citrate | | fatty acid esters | |
| | | | | | of glycerol | |
| Example 2-3 | Malic Acid | 75 | Potassium | 25 | Diacetyltartaric and | 150 |
| | | | Citrate | | fatty acid esters | |
| | | | | | of glycerol | |
| Example 2-4 | Malic Acid | 100 | Potassium | 75 | Diacetyltartaric and | 50 |
| | | | Citrate | | fatty acid esters | |
| | | | | | of glycerol | |
| Example 2-5 | Malic acid | 50 | Potassium | 50 | Diacetyltartaric and | 300 |
| | | | Citrate | | fatty acid esters | |
| | | | | | of glycerol | |
| Example 2-6 | Malic Acid | 75 | Sodium | 75 | Succinylated | 150 |
| | | | Malic Acid | | Monoglycerides | |
| Example 2-7 | Malic Acid | 75 | Potassium | 25 | Succinylated | 150 |
| | | | Citrate | | Monoglycerides | |
| Example 2-8 | Malic Acid | 100 | Potassium | 75 | Succinylated | 50 |
| | | | Citrate | | Monoglycerides | |
| Example 2-9 | Malic Acid | 50 | Potassium | 50 | Succinylated | 300 |
| | | | Citrate | | Monoglycerides | |

TABLE 4-2

| | 80° C., 3 Days | 60° C., 2 Weeks | 37° C., 4 Weeks |
|---|---|---|---|
| | Storage | Storage | Storage |
| | Stability | Stability | Stability |
| Example 2-1 | ± | + | ± |
| Example 2-2 | − to ± | ± to + | ± |
| Example 2-3 | − to ± | ± to + | ± |
| Example 2-4 | ± | + | ± |
| Example 2-5 | ± to + | + | ± |
| Example 2-6 | ± | + | ± to + |
| Example 2-7 | ± to + | ± to + | ± |
| Example 2-8 | − to ± | ± to + | − to ± |
| Example 2-9 | ± | + | ± |

As shown in Table 4-2, the precipitation was significantly inhibited in the coffee beverage containing a milk component of Examples 2-1 to 2-9, compared with the beverage of Reference Example 1-1. There was little precipitation or very small precipitation.

Further, the coffee beverage containing a milk component of Examples 2-1 to 2-9 maintained the taste of a coffee beverage; thus, these coffee beverages containing a milk component had an excellent, distinctive taste of coffee and milk.

### Experiment Example 3

### Coffee Beverage Containing a Milk Component (3)

### Preparation of Coffee Beverage Containing a Milk Component

Coffee beverages containing a milk component were prepared in the same manner as in Experiment Example 1, except that the beverages were prepared according to the formulas shown in Tables 5 and 6. The pH of each coffee beverage containing a milk component after sterilization was 6.2 to 6.3.

### Storage Stability Test

A storage stability test of the prepared coffee beverage containing a milk component was performed.

After each prepared coffee beverage containing a milk component was stored at 80° C. for 3 days, the container (can) was opened. Subsequently, the content (beverage) was transferred to a beaker, and the state of the precipitate that remained in the can bottom was visually evaluated.

The precipitation amount was visually evaluated as follows from the largest to the smallest precipitation: +++>++>+>±>−.

The beverage sample with large amount of precipitation comparing to that in Reference Example 3-1 was rated “+++”,

The beverage sample with a same amount of precipitation comparing to that in Reference Example 3-2 was rated “+”.

The beverage sample in which the precipitation amount was greatly reduced compared with Reference Example 3-1, i.e., the precipitation amount was small or precipitation was hardly observed was rated “−”.

Similar tests were performed in the same manner by changing the storage condition to 60° C. for 2 weeks, and 37° C. for 4 weeks.

Table 6-2 shows the results.

TABLE 5

| Formula of Coffee beverage | |
|---|---|
| containing a milk component | Mass % |
| Liquid coffee extract | 27.8 |
| Cow's Milk | 20 |
| Sugar | 6 |
| Organic Acid | See Table 6-1 |
| Organic Acid Salt | See Table 6-1 |
| Organic-acid ester of monoglyceride | See Table 6-1 |
| Sodium caseinate | See Table 6-1 |
| Sucrose ester of Fatty Acid | 0.05 |
| Sodium Bicarbonate | 0.11 |
| Total following the Addition of Ion Exchange Water | 100 |
| Coffee Component (Amount of Raw coffee Beans) | 4.5 |
| Milk Component (Amount of Nonfat Milk Solid) | 1.8 |

TABLE 6-1

| | | | | | | Organic-acid ester of | |
|---|---|---|---|---|---|---|---|
| | Sodium | Organic Acid | | Organic Acid Salt | | monoglyceride | |
| | caseinate | | Content | | Content | | Content |
| | (ppm) | Type | (ppm) | Type | (ppm) | Type | (ppm) |
| Reference | — | — | — | — | — | — | — |
| Example 3-1 | | | | | | | |
| Reference | 1000 | — | — | — | — | — | — |
| Example 3-2 | | | | | | | |
| Example 3-1 | — | Tartaric | 75 | Potassium | 75 | Diacetyltartaric | 150 |
| | | Acid | | Citrate | | and fatty | |
| | | | | | | acid esters | |
| | | | | | | of glycerol | |
| Example 3-2 | — | Malic | 75 | Potassium | 75 | Diacetyltartaric | 150 |
| | | Acid | | Citrate | | and fatty | |
| | | | | | | acid esters | |
| | | | | | | of glycerol | |

TABLE 6-2

| | 80° C., 3 Days | 60° C., 2 Weeks | 37° C., 4 Weeks |
|---|---|---|---|
| | Storage | Storage | Storage |
| | Stability | Stability | Stability |
| Reference | +++ | +++ | ++ |
| Example 3-1 | | | |
| Reference | + | ++ | + |
| Example 3-2 | | | |
| Example 3-1 | − | + | ± |
| Example 3-2 | − | + | ± |

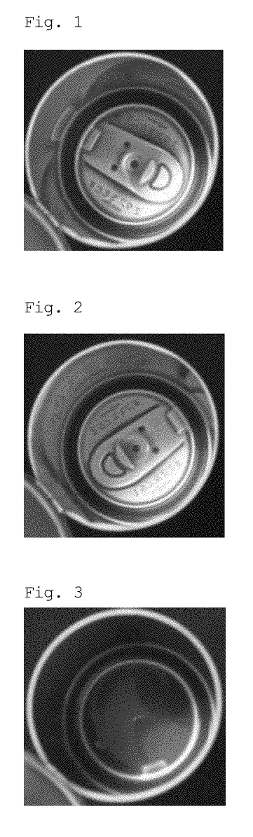

In the coffee beverage containing a milk component of Examples 3-1 and 3-2 containing the three components, i.e., organic acid, organic acid salt, and organic-acid ester of monoglyceride, the precipitation was greatly suppressed and was not observed in the container bottom (FIGS. 1 and 2).

Further, the coffee beverage containing a milk component of Examples 3-1 and 3-2 had an excellent, distinctive taste of coffee and milk.

In contrast, the coffee beverage containing a milk component of Reference Example 3-1 had a large amount of precipitation; the precipitation was confirmed in the entire bottom (FIG. 3).

### Experiment Example 4

### Coffee Beverage Containing a Milk Component (4)

### Preparation of Coffee Beverage Containing a Milk Component

Coffee beverages containing a milk component were prepared in the same manner as in Experiment Example 1, except that the beverages were prepared according to the formulas shown in Tables 7 and 8. The pH of each coffee beverage containing a milk component after sterilization was 6.2 to 6.3.

### Storage Stability Test

A storage stability test of the prepared coffee beverage containing a milk component was performed.

After each prepared coffee beverage containing a milk component was stored at 80° C. for 3 days, the container (can) was opened. Subsequently, the content (beverage) was transferred to a beaker, and the state of the precipitate that remained in the can bottom was visually evaluated.

The precipitation amount was visually evaluated from the largest to the smallest precipitation: +++>++>+>±>−.

The beverage sample with large amount of precipitation comparing to that in Reference Example 4-1 was rated “+++”.

The beverage sample with a same amount of precipitation comparing to that in Reference Example 4-2 was rated “+”.

The beverage sample with a precipitation amount similar to that in Reference Example 4-3 (in which the precipitation amount was greatly reduced compared with Reference Example 4-1, i.e., the precipitation amount was small or precipitation was hardly observed) was rated “−”.

The intermediate level in the evaluation was expressed as, for example, “− to ±”.

Table 7 shows the results.

As shown in Table 8, the inhibition of precipitation improved when sodium caseinate was used together. This increase in precipitation inhibition was confirmed even when a very small amount of sodium caseinate, which will not solely exert the effects as a precipitation inhibitor, was used.

TABLE 7

| Formula of Coffee beverage containing a milk component | Mass % |
|---|---|
| Liquid coffee extract | 40.0 |
| Cow's Milk | 15 |
| Sugar | 6 |
| Organic Acid | See Table 8 |
| Organic Acid Salt | See Table 8 |
| Organic-acid ester of monoglyceride | See Table 8 |
| Sodium caseinate | 0.05 |
| Sodium Bicarbonate | 0.11 |
| Total following the Addition of Ion Exchange Water | 100 |
| Coffee Component (Amount of Raw coffee Beans) | 7.3 |
| Milk Component (Amount of Nonfat Milk Solid) | 1.3 |

TABLE 8

| | | | | Diacetyltartaric | 80° C., |
|---|---|---|---|---|---|
| | Sodium | Malic | Potassium | and fatty acid | 3 Days |
| | caseinate | Acid | Citrate | esters of | Storage |
| | (ppm) | (ppm) | (ppm) | glycerol (ppm) | Stability |
| Reference | — | — | — | — | +++ |
| Example 4-1 | | | | | |
| Reference | 50 | — | — | — | + |
| Example 4-2 | | | | | |
| Reference | 100 | — | — | — | − |
| Example 4-3 | | | | | |
| Example 4-1 | — | 75 | 75 | 150 | ± |
| Example 4-2 | 25 | 75 | 75 | 150 | − to ± |
| Example 4-3 | 50 | 75 | 150 | 150 | − |
| Example 4-4 | 75 | 75 | 75 | 150 | − to ± |
| Example 4-5 | 100 | 75 | 75 | 150 | − to ± |
| Comparative | — | 75 | 75 | — | ++ |
| Example 4-1 | | | | | |

1. A coffee beverage containing a milk component comprising an organic acid, an organic acid salt, and an organic-acid ester of monoglyceride.

2. The coffee beverage containing a milk component according to claim 1, wherein the coffee beverage containing a milk component comprises 2.5 mass % or more of a coffee component in an amount of raw beans.

3. The coffee beverage containing a milk component according to claim 1, wherein the coffee beverage containing a milk component comprises 0.4 mass % or more of a milk component in an amount of nonfat milk solid.

4. The coffee beverage containing a milk component according to claim 1, wherein the coffee beverage containing a milk component comprises, as the organic acid, one or more members selected from the group consisting of malic acid, tartaric acid, and citric acid.

5. The coffee beverage containing a milk component according to claim 1, wherein the amount of the organic acid is not less than 50 ppm and less than 300 ppm.

6. The coffee beverage containing a milk component according to claim 1, wherein the coffee beverage containing a milk component comprises, as the organic acid salt, one or more members selected from the group consisting of citrates, malates, phosphates, and tartrates.

7. A method for inhibiting precipitation generated upon storage of a coffee beverage containing a milk component, comprising incorporating an organic acid, an organic acid salt, and an organic-acid ester of monoglyceride in the coffee beverage containing a milk component.

8. A method for producing a coffee beverage containing a milk component, comprising incorporating an organic acid, an organic acid salt, and an organic-acid ester of monoglyceride in the coffee beverage containing a milk component.
